(19) United States
(12) Patent Application Publication
(10) Pub. No.: US 2010/0021741 A1
(43) Pub. Date: Jan. 28, 2010

(54) METHOD FOR COATING A SEMIFINISHED PRODUCT

(75) Inventor: Anita Marten, Blaustein (DE)

Correspondence Address: PATENT CENTRAL LLC;Stephan A. Pendorf, 1401 Hollywood Boulevard, Hollywood, FL, 33020, US

(73) Assignee: DAIMLER AG, STUTTGART (DE)

(21) Appl. No.: 12/518,129

(22) PCT Filed: Dec. 3, 2007
(86) PCT No.: PCT/EP07/10465

§ 371 Date: Jun. 8, 2009

(30) Foreign Application Priority Data
Dec. 22, 2006 (DE) 10 2006 062 346.0

(51) Int. Cl. B32B 27/38; B05D 3/02; B05D 3/06; B05D 3/12

(52) U.S. Cl. 428/413; 427/379; 427/557; 427/558; 427/374.3; 427/289

(57) ABSTRACT

The invention relates to a method for coating a semifinished product (12) particularly a broad strip used for making motor vehicles, with a mixture (10), can be converted from a free-flowing state into a hardened state by chemically cross-linking said components. Said method encompasses the following steps: a.) the mixture (10) is applied to the semifinished product (12); b.) the mixture (10) is flash-hardened at a first temperature for a first period of time; c.) the flash-hardening process is interrupted; and d.) the mixture (10) is hardened at a second temperature for a second period of time, the second period of time being longer than the first period of time and/or the second temperature being greater than the first temperature. The invention further relates to a semifinished product (12) as well as a mixture (10), particularly a paint, for coating semifinished products (12).

The invention relates to a method for coating a semifinished product of the type given in the preamble of claim 1. The invention further relates to a semifinished product and a mixture of cross-linkable chemical components of the type given in claims 8 or 9.

Mixtures with cross-linkable chemical components which are used as organic coatings for semifinished products as for example broad strips for automotive bodies, serve for the permanent corrosion protection. They are usually applied to the semifinished products formed as broad strip rollers (so-called coils) by the steel manufacturer. The methods used for this and which are known per se, generally comprise the following steps after the cleaning of the semifinished product: applying the mixture, drying the mixture and hardening of the mixture in dependence on the components used respectively. In further steps, the semifinished product is cooled with the hardened mixture and coated with drawing oil or another oil. This process is accompanied by an extensive test approved after testing are subsequently delivered to automotive manufacturers. Different component parts are cut there from the pretreated semifinished products, formed and joined to bodies in white by means of different joining methods (e.g. resistance spot welding, laser welding, glueing, mechanical joining methods). Thereby, not only the semifinished product, but also the coating, is put under stress and damaged to a greater or lesser extent. In methods known up to now, the only partially by use of bonding agent components made more flexible and/or the addition of softeners and/or other softening components is counteracted, which accompanies a reduction of the corrosion protection performance or a preprogrammed ageing of the coating in dependence on the layer strength. The resulting body in white is subsequently cleaned and guided to further painting processes. It is hereby essential, that not all component parts have to be manufactured of organically coated material. Parts are used which are coated on both sides, on one side, in a varied manner, or not coated at all, which additionally can also consist of different and differently coated substrate materials (mixed construction method). Furthermore, not all surfaces are covered with the further painting (particularly flange regions, cavities) and surfaces are also deliberately painted differently or not at all (for example shell, inner part). The requirements which have to be demanded by these mixtures and semifinished products in addition to corrosion protection thus have the following aspects:

“Forming behavior” of the semifinished product or of the hardened mixture in connection with different amounts of drawing oil, where organic coatings usually already have an intended but differently shaped lubricating action;

“formability” of the semifinished product or of the hardened mixture, with which the adherence to the semifinished product and the corrosion protection of the coating are designated after a forming of the semifinished product;

“ability to join”, with which the compatibility of the hardened mixture with welding methods is described for example, which assume a sufficient electrical conductivity of the mixture. Furthermore, the compatibility of the mixture or of the coated semifinished product with laser welding methods, glueing methods and other, for example mechanical joining processes, is to be meant thereby.

In other words, the mixture (coating) used an as organic precoating has to have a compatibility with all relevant process steps during automotive engineering. A sufficient resistance to alkali of the coating is amongst this, if it is subjected to an alkaline cleansing after the body in white and prior to a further painting. The corresponding is for example valid for the consistency or compatibility with regard to pretreatment baths (e. g. phosphating bath) and subsequent painting processes (e. g. KTL), and for the solvent and UV resistance of the coating. Additionally, environmental, safety and economic aspects have to be considered.

In addition to requirements of the hardened mixture, there are also requirements of the free-flowing mixture. These relate amongst others to the storage stability, the setting behavior, and the ability to be stirred again especially when adding large amounts or heavy pigments. Further aspects to be observed comprise the viscosity and the rheological behavior of the fluid mixture and the solvent types suitable as reactive thinners.

The expert is aware of different mixtures used as organic coatings—often high temperature baking paints—by different manufacturers from the state of the art, which have the required requirement profile.

It is disadvantageous with the known methods for coating semifinished products and the mixtures suitable therefore, that these are very time-consuming and have to be hardened at comparatively high temperatures, and thus lead to increased production costs. It is disadvantageous with the known semifinished products that they have a relative brittle surface after the coating. This is often damaged by the following processing steps, which leads to a significant deterioration of the corrosion protection performance of the semifinished product.

It is thus the object of the present invention to create a method for coating a semifinished product which enables an improved corrosion protection performance of the coated semifinished product. It is a further object of the invention to provide a semifinished product with improved corrosion protection performance and a mixture which enables a coating of a semifinished product for protection against corrosion with reduced production costs.

The objects are solved according to the invention by a method with the characteristics of claim 1, a semifinished product according to claim 8, and a mixture according to claim 9. Advantageous embodiments with convenient and non-trivial further arrangements are given in the respective dependent claims, wherein advantageous embodiments of the method—as far as they can be used—should be viewed as advantageous embodiments of the semifinished product or the mixture and vice versa.

According to the invention, the method for coating a semiconductor comprises at least the steps a.) applying the mixture to the semifinished material, b.) flash-hardening the mixture at a first temperature for a first period of time, c.) interrupting the flash-hardening, and d.) hardening the mixture at a second temperature for a second period of time, the second period of time being longer than the first period of time and/or the second temperature being greater than the first temperature. In other words, the mixture is only cross-linked partially after the application to the semifinished product in steps b.) and c.), and the transition of the mixture into a higher-molecular state is controlled deliberately. The hardening of the mixture takes place step by step and initially in an incomplete manner by the interruption of the cross-linking in step c.). It can thereby be provided that steps b.) and/or c.) are carried out several times in succession. It is the advantage of the method according to the invention that the first flash-hardening can for example take place at a relatively low temperature and thus in line with a coil coating, whereby a cross-linked, touchproof, flexible and easily formable coating is achieved, but which has at least the properties and resistances necessary in the body in white or until the first paint step (e. g. formability, adherence on the semifinished product, weldability, resistance to cleaners, ability to phosphatize, ability to paint). The semifinished product with the flash-hardened coating can then reach the desired corrosion protection performance especially also at the formed component part, only at a later suitable time, preferably during or after the body in white and preferably in line with a further temperature step at a higher temperature and/or longer period of time then is usual with coil coating which is necessary in any case. This is ensured in that an automatic repair is possible with stressed and damaged regions of the semifinished product by a flowability of the flash-hardened mixture which is still present. The hardening in step d.) and thus the final state of the coating thus takes place after the repair of the damaged regions, so that a particularly high corrosion protection performance is ensured. The flash-hardening and the hardening can both times be carried out in a thermal manner, a flash-hardening by irradiation with IR or UV radiation is however also feasible, and subsequent thermal hardening.

A further aspect of the invention relates to a mixture, particularly a paint, for coating semifinished products, which comprises the following cross-linkable components:
a phenolic resin,
an epoxy resin,
a blocked isocyanate,
a reactive thinner,
   wherein the mixture (10) is to be converted from a free-flowing state to a hardened state by cross-linking the components. Such a mixture formed as a low cure paint has the advantage that a specific cross-linking which takes place step by step is permitted and thus enables a corrosion protection coating of a semifinished product with reduced production costs. The design as low cure paint is, in addition to the ecological advantages, important due to two further reasons, namely that the processing of certain types of steel, the bake-hardening steels, is thereby possible and that the production speed can be increased. For this, it is necessary that an object temperature of about 170° C. is not exceeded under coil coating conditions (typical drying time 30 s, afterwards quenching in water), and that the necessary performance is nevertheless achieved. Contrary to the state of the art, the admixing of catalysts can advantageously be foregone, whereby the mixture has a high storage stability. But this does not exclude that catalysts or reaction accelerators can possibly nevertheless be provided. The raw material usage can be limited by a high storage stability and further cost reductions can be achieved. Thus, the desired starting and end performance of the coating can be achieved through the mixture according to the invention. A sufficient storage stability in delivery form and after use by the preferred waiving of catalysts or accelerators can additionally be realized.

Further advantages, characteristics and details of the invention result from the following descriptions of individual embodiments and by means of the drawings. It shows thereby:

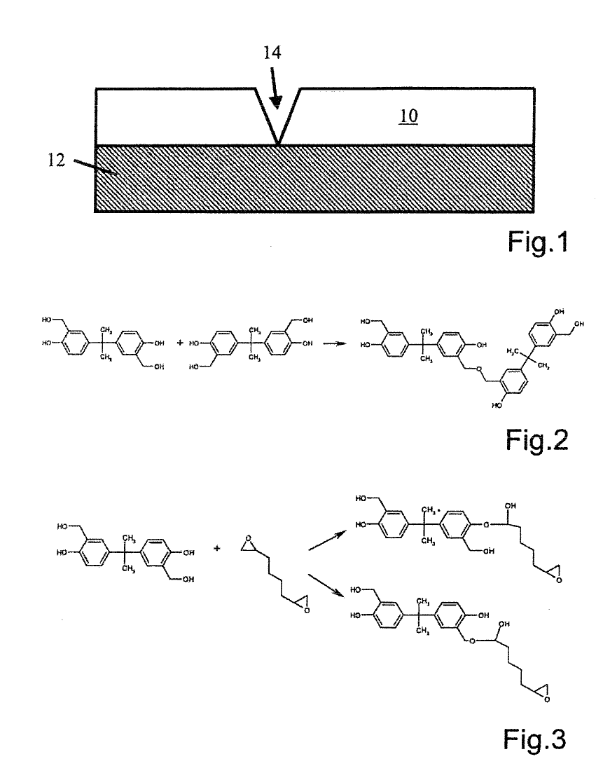

FIG. 1 a schematic sectional view of a semifinished product coated with a hardenable mixture;

FIG. 2 a schematic depiction of a reaction between two phenolic resin components of a mixture according to FIG. 1;

FIG. 3 a schematic depiction of a reaction between a phenolic resin and an epoxy resin component of the mixture according to FIG. 1 and 2;

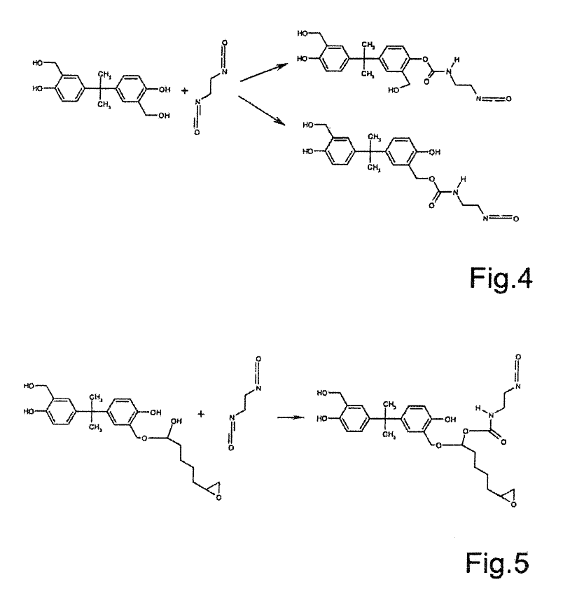

FIG. 4 a schematic depiction of a reaction between a phenolic resin component and a blocked isocyanate of the mixture according to FIG. 1 to 3;

FIG. 5 a schematic depiction of a reaction between reaction product according to FIG. 3 and a blocked isocyanate of the mixture according to FIG. 1 to 4.

FIG. 1 shows a schematic sectional view of a semifinished product 12 coated with a hardenable mixture 10. The mixture thereby comprises several chemical cross-linkable components, which are explained in more detail in the following. After applying the initially free-flowing mixture 10 to the semifinished product 12 with the help of a coating method, a partial cross-linking and thus a flash-hardening of the mixture 10 is achieved by means of heating or irradiation with infrared or UV radiation. After a predetermined period, the flash-hardening is interrupted, for example by quenching the mixture 10 with water. The coated semifinished product 12 can then be subjected to further processing methods as for example forming, welding or joining. But this often leads to a damage 14 of the coating and thus to an impairment of the corrosion protection performance. Due to the still free-flowing state of the mixture 10, this can however repair the damage 14 automatically by flowing over. A final hardening of the mixture 10 can subsequently take place and the semifinished product 12 can be optimally protected against corrosion. The flash-hardening in step b.) can for example take place at about 170° C. for 30s and can be stopped by subsequent quenching with water in step c.). This has the advantage that the production speed during strip coating is increased, and thus the production costs are reduced compared to previous coating methods. The flash-hardening at 170° C. additionally permits the processing of bake-hardening steels, which would harden with the otherwise usual temperatures of 200-250° C. by inclusion of nitrogen. If bake-hardening steels are not used, a flash-hardening at higher temperatures can however be provided. The hardening in step d.) can—for example in line with a tempering step which is necessary in any case during a further processing of the coated semifinished product 12—then take place for about 30 minutes at 170-180° C. Mixtures 10 cross-linking at a slower rate can be heated at a correspondingly higher temperature or for a longer period, where a throughput time and plant utilization as high as possible is provided.

The mixture 10 thereby initially comprises a phenolic resin, and epoxy resin, a blocked isocyanate and a reactive thinner as cross-linkable components. Further components can be provided additionally, which are elaborated on in the following embodiments. The reference material which can be obtained from VDEh serves as orientation for the achievable corrosion protection performance. This consists of DC 04 steel material electrolytically coated on both sides with about 7.5 μm zinc (ZE75/75), which was subsequently initially coated on both sides with a chromium-free pretreatment and then with a corrosion protection primer layer of exactly 3.6 μm consisting of Granocoat ZE (Fa. Henkel). Flange samples manufactured from this reference coil are attributed that they survive 10 weeks of changing test in the flange region according to VDA 621-415 without damage without red rust, where white rust is allowed. Differences of the individual test chambers and the like are to be eliminated in this manner. This corrosion protection performance corresponds to the one of the 1^{st} generation according to the definition. The corrosion requirements for the 2^{nd} generation are twice as high, are thus 20 weeks testing time without red rust with the same layer strength. If the reference flange samples manufactured from the reference coil in one test chamber would already display red rust after 6 weeks, this result is allocated the performance of the 1^{st} generation, and would have to pass through a simultaneously tested new primer coating with the same layer thickness of only 9 or 12 weeks testing time to be able to verify the performance of the 1.5 or 2^{nd} generation. The other requirements are minimum requirements, which have to be fulfilled, with spot welding, this is for example a welding region of at least 1.3 kA, an electrode standing amount of at least 800 points and freedom of splashing. There are also requirements for glueing, forming, adherence etc, which are not allowed to be undercut. Insofar, the statement is sufficient regarding which corrosion protection performance was achieved, and the resilient statement that all other requirements are at least fulfilled or have been surpassed in the positive sense. Thicker layers than the given 3.6 μm partially lead to a better corrosion protection performance. However, a higher material and cost effort is opposed to this, and the other performance requirements also have to be fulfilled here. If the question of costs is clarified, nothing would be in the way of possibly coating a material with a thicker layer. However, to be able to rank it with regard to performance, the coating with a layer strength of 3.6 μm is nevertheless advised. Alternatively, coatings with a layer strength in the region of 1-2.5 μm are feasible, but which should at least have the performance of the 1^{st} generation. The corrosion protection performance of the 3.6 μm layer of the reference coil are here directly compared to a 1.8 μm coating of the new development as given above. The reason for this measure is the cost savings due to a low material usage.

Table 1 describes a composition of the mixture 10 for coating the semifinished product 12 according to a first embodiment, where the achieved corrosion protection performance with half the layer strength and reduced costs corresponds to a paint of the state of the art (1st generation)

TABLE 1
Composition of a mixture for coating semifinished products according
to a first embodiment (LLC42)

| Phenolic resin 55% | 4.30 | g |
|---|---|---|
| Epoxy resin | 2.70 | g |
| Blocked isocyanate 75% | 14.75 | g |
| Reactive thinner | 2.59 | g |
| Zinc 1 | 18.72 | g |
| Tungsten | 3.74 | g |
| Corrosion protection pigment 1 | 6.55 | g |
| Corrosion protection pigment 3 | 4.68 | g |
| Inhibitor 1 | 0.94 | g |
| Inhibitor 2 | 0.94 | g |
| Thickener | 1.87 | g |
| Rheology additive | 0.15 | g |
| Dispersing additive | 0.26 | g |
| Progress additive | 0.20 | g |
| Solvent | 37.62 | g |
| Sum: | 100 | g |
| Solid content | 55.3% | |
| Layer thickness | 1.8 | μm |

| | |
|---|---|
| Welding result | Good |
| Corrosion result | => 1^{st} |
| | generation |

0.3-2 parts of zinc powder and 0.1 to 0.5 parts tungsten are added to one part by weight of the bonding agent components. The solid content is for example 30 to 65%.

Table 2 describes a composition of the mixture 10 for coating the semifinished product 12 according to a second embodiment, where the classic arrangement of a zinc powder color of the 2nd generation is achieved. The corrosion protection performance which can he achieved is thereby twice as good compared to the state of the art (1st generation) with the same layer strength and price.

TABLE 2
Composition of a mixture for coating semifinished products according
to a second embodiment (LC90)

| Phenolic resin 55% | 3.50 | g |
|---|---|---|
| Epoxy resin | 1.47 | g |
| Blocked isocyanate 75% | 12.01 | g |
| Reactive thinner | 2.11 | g |
| Zinc 2 | 58.04 | g |
| Corrosion protection pigment 1 | 3.63 | g |
| Corrosion protection pigment 3 | 3.63 | g |
| Inhibitor 1 | 0.73 | g |
| Inhibitor 2 | 0.73 | g |
| Thickener | 0.44 | g |
| Rheology additive | 0.15 | g |
| Dispersing additive | 0.26 | g |
| Progress additive | 0.20 | g |
| Solvent | 13.13 | g |
| Sum: | 100 | g |
| Solid body | 81.5% | |
| Layer thickness | 3.6 | μm |

| | |
|---|---|
| Welding result | Good |
| Corrosion result | => 2^{nd} |
| | generation |

2.5-4 parts of zinc powder are added to one part by weight of the bonding agent components. The solid content is for example 65 to 92%.

Table 3 describes a composition of the mixture 10 for coating the semifinished product 12 according to a third embodiment, which corresponds to a zinc powder color of the 2nd generation. The corrosion protection performance which can be achieved however corresponds to more than twice than the mixtures known from the state of the art with the same layer strength and the same price.

TABLE 3
Composition of a mixture for coating semifinished products according
to a third embodiment (LC70)

| Phenolic resin 55% | 4.72 | g |
|---|---|---|
| Epoxy resin | 1.98 | g |
| Blocked isocyanate 75% | 16.20 | g |
| Reactive thinner | 2.84 | g |
| Zinc 1 | 39.14 | g |
| Tungsten | 2.61 | g |
| Corrosion protection pigment 2 | 24.46 | g |
| 25% | | |
| Corrosion protection pigment 3 | 4.89 | g |
| Inhibitor 1 | 0.98 | g |
| Inhibitor 2 | 0.98 | g |
| Thickener | 0.59 | g |
| Rheology additive | 0.15 | g |
| Dispersing additive | 0.26 | g |
| Progress additive | 0.20 | g |
| Sum: | 100 | g |
| Solid content | 73.4% | |
| Layer thickness | 3.6 | μm |

| | |
|---|---|
| Welding result | Good |
| Corrosion result | => 3^{rd} |
| | generation |

1-3 parts of zinc powder and 0.1 to 0.5 parts of tungsten are added to one part by weight of the bonding agent components. The solid content is for example 40 to 85%.

It has been shown to be advantageous for all compositions that the part of corrosion protection pigments is 2-20%, the part of inhibitors 1-10%, and the part of other additives 0.2-4%. The added amounts of tungsten can however also be substituted by molybdenum, by for example adding the same weight amount or only up to 60% of the weight amount of molybdenum.

An advantage of the method of the semifinished product 12 and the mixture 10 consists in the consideration of the different processing methods to which the coated semifinished product 12 can be subjected, as it has to be observed that an automobile consists nearly exclusively of parts which are formed or joined in a more or less strong manner.

In FIG. 2 to 5 are shown different cross-linking reactions schematically running between the phenolic resin, the epoxy resin, the blocked isocyanate and corresponding reaction products of the previous reactions.

FIG. 2 thereby shows an intermolecular ether formation between aliphatic alcohol groups of two bishenol A molecules serving as phenolic resin component. Additional or alternative phenolic resin components could however also be provided instead of bisphenol A.

FIG. 3 shows possible reactions between bisphenol A serving as phenolic resin component and 1,2,7,8 diepoxy octane, which serves as epoxy resin component. New alcohol groups thereby result from the ring opening of the epoxy, which enable a further cross-linking of the reaction product in following reactions (FIG. 5). The reaction can thereby take place via aliphatic and also via aromatic alcohol groups of the bisphenol A molecule. Additional or alternative epoxy resin components can also be provided instead of 1, 9, 7, 8 diepoxy octane.

FIG. 4 shows possible reactions between the phenolic resin component bisphenol A and dimethylene diisicyanate, which serves as isocyanate component and is presently shown in an unblocked manner. Malonic acid diethyl ester (not shown) is for example suitable as blocking means. Alternative blocking means are also feasible. Alternatively or additionally, further isocyantaes as for example hexamethylene diisocyanate (HDI), methylene diphenyl diisocyanate (MDI), toluene diisocyanate (TDI), isophoron diisocyanate (IPDI) or cyclohexyl diisocyanate (CHDI) can also be provided instead of dimethylene diisocyanate.

FIG. 5 shows a possible reaction between the reaction product from the phenolic resin component bisphenol A and the epoxy resin component 1, 2, 7, 8-diepoxy octane according to FIG. 3 and the isocyantae component dimethylene diisocyanate—shown unblocked—which is added to an alcohol group resulting through the ring opening of the epoxy resin component.

In addition to the mentioned cross-linking components, the mixture 10 can comprise further components, so as to further improve the durability and storability, the processability and the corrosion protection performance. The corrosion protection performance can be improved further while maintaining the weldability by a suitable combination of different corrosion protection means which are added to the coating substance and which develop their effect at once or later. As already mentioned, the semifinished product 12 coated with the mixture 10 is first only cross-linked until achieving the performance necessary for the further processing, and is further cross-linked at the earliest after carrying out relevant process steps, namely after the forming and advantageously after the (laser or resistance spot) welding or glueing preferably in line with one or several preferred tempering steps, which are necessary anyway, wherein the material which can still be softened under the effect of heat or is still free-flowing for a short time while completely or partially repairing damaged forming regions and/or partially uncoated regions (e.g. scratches, to a certain extent also trimmed edges), is transferred directly or in steps to its final hardened state. A bonding agent component can additionally be provided for this, which can be chosen in an ecological and economic advantageous manner.

In contrast to the state of the art, a catalyst or accelerator does not necessarily have to be added to the mixture 10, to for example to achieve a flash-hardening under low cure coil coating conditions (temperature of the object about 100-180° C., drying time about 25-40 s). In this manner, the corrosion protection effect of the mixture 10 can be increased altogether, delamination can be reduced, and the susceptibility to corrosion can be repressed particularly in damaged or formed regions and in overlapping regions.

The mixture 10 can thereby be formed as a 1 component system (1K) or 2 component system (2K), where a sufficient storage stability can be realized in both cases. With 2K systems, the storage stability of the individual components is often sufficient, as long as the affected components are stored separately from one another. The essentially conceivable addition of catalysts can also influence the hardening conditions positively in a desired manner.

With 1K systems, sufficiently reactive components are however sensible with low cure paints, if a sufficiently high cross-linking or performance of the coating is to be achieved at a lower temperature and/or shorter period of time. With the background of the necessary storages of liquid paint, even under different conditions (time, temperature), a longer storage is often excluded by the given impact of catalysts and/or accelerators for different reasons, and/or often harbors a high risk regarding the process safety. This is valid for the classic 1K system, which is possibly supplied with catalyst/accelerator, and for the storage of residual amounts to be reused, if the catalyst/accelerator is only added prior to the first use in the sense of a 2K system. A considerable reduction of the production costs can be achieved not only due to this reason, but partially also with regard to the achieved corrosion protection effect with the mixture 10 or method introduced here, which essentially manages without the use of catalysts or accelerators.

The hardening of the mixture 10 in two or several steps differs from the mixtures and methods previously known in that advantageous combinations of lower and higher molecular components with higher and lower reactivity are provided, which have a plurality of different cross-linking or different reaction possibilities, and where even new reactive groups are formed by the cross-linking reactions, which can undergo further cross-linking reactions on their part.

The method also provides that the cross-linking can take place thermally with different temperatures. and also by means of different drying times, and also energetically via different activation energies of different bonding agent components or also combinations thereof in a step-by-step manner. A flexible, cross-linked material is thereby available after the partial cross-linking, which can be formed easily and welded well, but which necessarily does not have to have the final corrosion protection performance. A high molecular dense polymer network with a high corrosion protection effect and extensive resistances is formed in line with later tempering steps while repairing damaged regions. As catalysts and accelerators, typically zinc and zinc salts and tertiary amines are not compellingly necessary for carrying out the method or with the design of the mixture 10, the first hardening step takes place for example under coil baking conditions within about 30s dwelling time in the oven and with a maximum temperature of the object of about 170° C.

In an advantageous design of the mixture 10, a solvent is provided as a further component, where a design of the mixture 10 as a high solid paint system can alternatively also be provided. It can be ensured by a solvent or solvent mixture that the individual components of the mixture 10 are held optimally in the solution. Furthermore, the solvent can itself take part in the cross-linking reactions in a systematic manner and form the reactive thinner component. Alternatively, an inert solvent can be provided for the proceeding reactions, which preferably also does not show any interactions with the devices (e.g. scraper, coating roller etc.) used for applying the mixture 10 or for further processing the semifinished product 12. The use of a solvent further offers the advantage that it can support the individual components of the mixture 10 during its reactions. The used solvent component has a further importance under the coil coating conditions, as it can be used for adjusting a suitable thinning (viscosity, rheological behavior) for the processing of the mixture 10. The solvent can thereby leave the coating open on the one hand during drying for a time long enough in dependence on its boiling point or its evaporation number, but can evaporate on the other hand to a desired amount at the end of the short drying time. It has to be considered thereby that the type and amount especially of the solvent remaining in the coating can possibly influence the corrosion protection effect. The addition of unnecessary solvent is preferably avoided for ecological and economic reasons, if it only has to be evaporated subsequently, but otherwise does not have any function. However, solvent additions have been shown to be advantageous, so as to be able to carry out viscosity adjustments for coater-suitable wet layer thicknesses for intended (particularly thin) dry layer thicknesses. The thinning degree is thereby chosen to be as low as possible, preferably using one or several reactive thinners, which are advantageously integrated chemically in the coating and thereby do not have to be evaporated, where additionally a further solvent or solvent mixture is often used to ensure the above-mentioned requirements as well as possible. Methoxy propyl acetate, butyl acetate, methoxy propanol, butanol, methyl ethyl ketone, methyl isobutyl ketone, cyclohexanone or its positional isomers are for example suitable as solvents. Mixtures of the listed solvents or other solvents such as ester and/or alcohols and/or hydrocarbons or the like can however also be provided. Suitable solvents or solvent mixture are basically characterized in that they have good solution properties for the respective concrete design of the mixture 10, have a suitable boiling point and a suitable evaporation number, and that they neither evaporate too fast or too slow under coil coating conditions, and that no unnecessary solvent residues remain in the flash-hardened mixture 10.

The mixture 10 or the coating is a functional coating. The introduction of certain functions thereby preferably takes place not exclusively via the components which are attributed to the bonding agent. An intrinsic flexibility, hydrophobizing, and the adjustment of the alkaline resistance can for example be effected in line with the cross-linking. Furthermore, a certain arrangement or alignment (self-orientation) of certain molecules or molecule groups can be achieved by including suitable contact or detainment groups. Additionally, further functions are introduced into the coating by introducing further substances into the polymer matrix, which are not chemically bonded.

It can further be provided to add additional corrosion protection means to the mixture 10. Inhibitors, corrosion protection pigments and/or hydrophobizing means are e.g. considered here. Inhibitors are substances which are able to reduce the corrosion attack on metal, even when used in small amounts, by slowing down corrosion reactions at least for a certain time or to prevent them to a large extent. This can take place in a different manner, for example by improving the adherence, by reducing the porosity, by reducing the permeability of coatings and/or by potential displacements which are connected to an inhibition effect, wherein preferred materials have the property to affect in several manners simultaneously. The corresponding is valid for corrosion protection pigments which are used in the form of solid bodies. Materials with a purely physical barrier effect are also available here as e.g. iron mica and reactive materials which act chemically or electrochemically as e.g. zinc (sacrificial anode), where reaction product resulting there can again have a physical effect by its ability to close resulting defects mechanically. When zinc flakes are used, it is possible to carry out the mentioned modes of operation with regard to corrosion protection and electrical conductivity only through one product. A further possibility to ensure a comprehensive corrosion protection is hydrophobizing which serves for making the coating water-repellant at its surface (waxes) and/or also intrinsically. The water penetration necessary for the corrosion is hampered by this measure. As the mixture 10 can amongst others also be formed in a weldable manner, it is advantageous that the coating has a relative good electrical conductivity. Thus, multifunctional corrosion protection means can preferably be used with the arrangement, which have further desired functions in addition to their actual functions, as e.g. additionally a certain intrinsic conductivity or do not disrupt or only in a justifiable low manner.

It has further been shown to be advantageous in a further design that the mixture 10 has a high electrical conductivity. This can be achieved by addition of conductive components. The use of sufficiently conducting coating substance could thereby fulfill these requirements theoretically. Usually, electrically conductive solid bodies (conducting pigments) will be added, which are embedded in the polymer matrix. The use of multifunctional zinc as conducting pigment is thereby particularly advantageous, which does not wear the tool for the forming processes to be carried out and is sufficiently ductile, and thereby acts in a repairing manner on forming damages and offers corrosion protection in several respects. Furthermore, the high filling degree for adjusting the weldability plays an important part, as the cathodic protection can be increased thereby. The performance of the mixture 10 can be adjusted optimally to the respective use by a suitable choice of particle size, particle size distribution, homogenic distribution of the particles in the mixture 10 (dispersability, stabilization) and the purity of the zinc. It has thereby been shown to be advantageous to use metallic zinc with a narrow particle size distribution and a medium particle size, which are in the region of the desired dry layer thickness, where a low part of particles can project from the layer. Alternatively, other conducting pigments or mixtures thereof are available, depending on use, possibly additionally in combination with zinc. The preferred designs according to the invention are thus mixtures of zinc with other conducting pigments, preferably molybdenum and/or tungsten, where these components are preferably also used with a narrow distribution, but with a considerably lower average particle size than zinc. While the bonding agent/conductivity pigment ratio can be in the region of 1:4 weight parts with the zinc-pigmented coating according to the invention, it can be lowered with the modified and alternatively pigmented design to about 1:0.5 to 1:3. This has the advantage that a rather closed paint film is produced, which has a skin capability with low raw material costs. A cost-effective and/or design suitable for the skin with excellent suitability for welding can thereby be provided by reduction of the layer strength and an altogether reduced raw material usage with the same corrosion protection performance. Basically, all sufficiently conductive substances such as Zn, Al, Mo, W, MoB₂, Fe₂B, Fe₂P or suitable alloys can be used as conducting pigments. Particularly, alloys or mixtures containing Zn or Al, agglomerates, assemblies, composite materials and/or materials thereof applied to carrier materials or arbitrary mixtures thereof can also be provided, which additionally can have a different corn size distribution.

It can further be provided that inhibitors, thickeners, rheology additives, dispersion additives or process additives are added to improve the storability and durability of the free-flowing mixture 10. The durability is for example influenced by chemical ageing of individual components and by physical effects. By adding one or several of the above-mentioned components to the mixture 10, a long processing period (work life) and a reproducible quality (performance) of the hardened mixture 10 can be guaranteed over the entire work life. As has already been mentioned, the mixture 10 can also be subjected to physical ageing during storage, for example caused by sedimentation of solid pigment components. This can also be prevented by the addition of such a component, so that a homogeneous and finely dispersed mixture 10 is obtained, which can be coated in an interference-free manner. So as to adjust certain properties of the free-flowing mixture 10 also in the hardened state, corresponding additives are provided. Wetting and dispersion additives have to be mentioned here first, which serve for comminuting pigment agglomerates and to wet the newly resulting surfaces. This state is subsequently stabilized, that is, for example obtained by electrostatic rejection, and reagglomeration is thereby permanently prevented. Furthermore. anti-setting additives can be provided, which prevent the setting particularly of heavy particles as a solid deposit and ensure their ability to be stirred up again. These additives, of which are different realization possibilities, can already coat the pigments in small concentrations (high resistance) and/or can enrich themselves on the surface of the coating. For example, certain waxes can be used therefore, which melt during welding and are additionally beneficial for the corrosion protection due to their hydrophobizing effect. Furthermore additives, which influence the rheology of the liquid paint by establishing stabilizing network structures, can be used as anti-setting means. With particularly thin fluid formulations, it can—so as to prevent adjustment conditions at the coater which are too extreme—be advantageous to use suitable thickeners. It can be furthermore be advantageous to use additives which produce or improve the coating quality, as for example substrate wetters, slide and progress additives, defoamers or vents. Different additives can thereby combined with one another in an advantageous manner and an optimum corrosion protection can be achieved as a result. It has also been shown to be advantageous that rheology additives which form the characteristic network with a time delay, can also still influence the desired anti-setting effect in a beneficial manner and that the mixture 10 can simultaneously be processed better on a coater.

It has further been shown to be advantageous that the hardening of the mixture 10 according to step d.) takes place in line with a KT coating in the automotive factory. So as to be able to obtain an optimal corrosion protection performance, it has been shown to be advantageous that the hardening preferably already takes place prior to the painting processes in the automotive factory and is for example advanced to the body in white or in line with drying of an adhesive.

It has to be stressed hereby that the method or the semifinished product 12 or the mixture 10 are not to be seen limited to the automotive area or coil coating. According to this, it can preferably be used in the automotive area, preferably but not compellingly where coil ware and/or preferably but not compellingly where plane parts are to be coated entirely or partially. It is also conceivable that only individual parts or certain regions are precoated by parts or are coated in the factory by a supplier. In addition to roller coating, other coating methods are also conceivable such as printing or spraying. The coil coating can also be extended to the further painting or front and rear side can also be coated differently. As the pigmentation with conductive pigment is only necessary with spot welding, it can be foregone in usage cases where this is not the case. If necessary, a cheaper substitute substance (filler) or a substitute substance effective with regard to corrosion protection or a corrosion protection pigment or mixtures therefrom can be added.

The mixture 10 can thus alternatively comprise a combination of suitable and sufficiently reactive bonding agent components with different reaction possibilities. This can for example be realized by the mixture of different bonding agents and/or differently functionalized bonding agents and/or combinations thereof, wherein, as has already been mentioned, phenolic epoxy functionalized and/or isocyanate-containing and/or components derived therefrom, are provided, so that the mixture 10 has the required low cure properties, even without the use of one or several catalysts and/or accelerators.

### LIST OF REFERENCE NUMERALS

10 Mixture
12 Semifinished product
14 Damage

1. A method Method for coating a semifinished product (12), particularly a broad strip for automotive engineering, with a mixture (10), especially a paint, which comprises cross-linkable chemical components and can be converted from a free-flowing state into a hardened state, comprising the following steps:
a) applying the mixture (10) to the semifinished product (12);
b) flash-hardening the mixture at a first temperature for a first period of time;
c) interrupting the flash-hardening;
d) hardening the mixture (10) at a second temperature for a second period of time, the second period of time being longer than the first period of time and/or the second temperature being greater than the first temperature.

2. The method according to claim 1, wherein, in step a.), a coating method is used, especially a cylinder coating method and/or a pressure coating method and/or a spray-paint method.

3. The method according to claim 1, wherein the mixture (10) is dried at least partially prior to step b.).

4. The method according to claim 1, wherein the mixture (10) is flash-hardened in step b.) by heating or irradiating with infrared and/or ultraviolet radiation.

5. The method according to claim 1, wherein the flash-hardening is interrupted in step c.) by quenching the mixture with a fluid, especially water.

6. The method according to claim 1, wherein the flash-hardened mixture (10) is coated with an oil, especially a drawing oil, in an additional step e.) after step c.).

7. The method according to claim 1, wherein, after step c.) and/or possibly step e.), the semifinished product (12) is formed in an additional step f.), especially deep-drawn and/or separated, especially cut, and/or joined, especially glued and/or welded and/or coated, particularly painted.

8.-11. (canceled)

12. The method according to claim 1, wherein a mixture (10), especially paint, is used for coating semifinished products (12), comprising the following cross-linkable components:
a phenolic resin;
an epoxy resin,
a blocked isocyanate;
a reactive thinner,
wherein the mixture (10) is to be converted from a free-flowing state to a hardened state by cross-linking the components.

13. The method according to claim 12, wherein a mixture (10) with the following composition is used:
phenolic resin (55%) between 3% and 5% (w/w);
epoxy resin between 1% and 3% (w/w);
blocked isocyanate (75%) between 11% and 17% (w/w),
reactive thinner between 1.5% and 3% (w/w).

14. The method according to claim 12, wherein a metal pigment and/or a corrosion protection pigment and/or an inhibitor and/or a thickener and/or rheology additive and/or dispersion additive and/or a progress additive and/or a solvent is additionally provided as component part of the mixture (10).

15. A coated semifinished product (12), particularly broad strip for automotive engineering, produced by coating a semifinished product (12) with a mixture (10), especially a paint, which comprises cross-linkable chemical components and can be converted from a free-flowing state into a hardened state, the method comprising the following steps:
a) applying the mixture (10) to the semifinished product (12);
b) flash-hardening the mixture at a first temperature for a first period of time;
c) interrupting the flash-hardening;
d) hardening the mixture (10) at a second temperature for a second period of time, the second period of time being longer than the first period of time and/or the second temperature being greater than the first temperature.
